(19) United States
(12) Patent Application Publication
(10) Pub. No.: US 2026/0291745 A1
(43) Pub. Date: Sep. 24, 2026

(54) Distributed Agent Continuity Management System for Persistent Operational Identity of Artificial Intelligence Agents Across Heterogeneous Agent Execution Nodes or Computing Platforms

(71) Applicant: ALEXANDER JOHN BRACKEN, DUBAI (AE)

(72) Inventor: ALEXANDER JOHN BRACKEN, DUBAI (AE)

(21) Appl. No.: 19/693,467

(22) Filed: May 31, 2026

Related U.S. Application Data
(63) Continuation-in-part of application No. 19/418,946, filed on Dec. 13, 2025.
(60) Provisional application No. 63/913,268, filed on Nov. 7, 2025.
(60) Provisional application No. 63/913,146, filed on Nov. 7, 2025.
(60) Provisional application No. 63/914,032, filed on Nov. 8, 2025.
(60) Provisional application No. 63/921,315, filed on Nov. 20, 2025.
(60) Provisional application No. 63/930,668, filed on Dec. 3, 2025.
(60) Provisional application No. 63/930,661, filed on Dec. 3, 2025.

(51) Int. Cl. H04L 9/32; H04L 9/00; H04L 9/08

(52) U.S. Cl. CPC H04L 9/3234; H04L 9/0894; H04L 9/50

(57) ABSTRACT

A distributed agent continuity management system maintains persistent operational identity of an artificial intelligence agent across heterogeneous agent execution nodes. A continuity anchor device derives a non-invertible continuity token from one or more of digital persona signatures, behavioral interaction profiles, or autonomous agent state fingerprints combined with a device-specific secret value stored within secure enclaves or trusted execution hardware. Encrypted agent continuity state data is indexed to the continuity token in a locally encrypted memory store. Continuity restoration is authorized upon similarity-based re-derivation of the continuity token and anchor-local validation using locally retained cryptographic key material, without requiring centralized identity provider authentication or cloud-hosted memory retrieval. Remote authentication, federated identity assertion, and external authorization events are insufficient by themselves to authorize continuity restoration absent local validation within the continuity anchor device.

### CROSS-REFERENCE TO RELATED APPLICATIONS (CONTINUATION-IN-PART)

This application is a continuation-in-part of U.S. Non-Provisional patent application No. 19/418,946, filed Dec. 13, 2025, titled ‘Systems and Methods for Biometric Continuity Token-Based Conversational Continuity Across Interfaced Computing Devices’ (‘Parent Application’). The Parent Application is incorporated herein by reference in its entirety. This application includes subject matter disclosed in the Parent Application and further includes additional subject matter directed to distributed agent continuity management, including the agent-continuity embodiments described in Section 6.15 and related portions of the specification, abstract, summary, drawings, and claims.

This application claims the benefit of priority to the following U.S. Provisional Patent Applications (as identified in the Parent Application), each incorporated by reference in its entirety for all purposes:
U.S. Provisional Application No. 63/930,668, filed Dec. 3, 2025
U.S. Provisional Application No. 63/930,661, filed Dec. 3, 2025
U.S. Provisional Application No. 63/921,315, filed Nov. 20, 2025
U.S. Provisional Application No. 63/914,032, filed Nov. 8, 2025
U.S. Provisional Application No. 63/913,268, filed Nov. 7, 2025
U.S. Provisional Application No. 63/913,146, filed Nov. 7, 2025

### STATEMENT REGARDING FEDERALLY SPONSORED RESEARCH: Not Applicable.

SEQUENCE LISTING: Not Applicable.

### FIELD OF THE INVENTION

The present disclosure relates generally to computer-implemented biometric security systems and continuity architectures and, more particularly, to systems and methods for maintaining persistent user-interactive session continuity across multiple computing interfaces through locally derived biometric or interaction-based identity tokens without reliance on centralized cloud identity services or persistent remote memory repositories.

### BACKGROUND OF THE INVENTION

Modern interactive computing platforms depend heavily on remote authentication servers, persistent cloud user accounts, centralized identity providers, and cloud-based memory repositories to maintain continuity of services and conversational state across devices. These architectures introduce substantial privacy risks, data leakage concerns, identity theft exposure, platform lock-in dependencies, jurisdictional regulatory conflicts, and service discontinuity failures during network outages, device transitions, or account deactivation events. Existing biometric authentication systems typically require permanent storage of raw biometric identifiers or depend on centralized biometric comparison networks. These approaches introduce long-term privacy and security risks and make true user ownership of personal identity and continuity technically difficult or infeasible. Users must often trust external parties to retain, protect, and control access to deeply personal identity data.

Conversational and generative AI systems increasingly span heterogeneous platforms, including wearable devices, vehicles, robotic systems, entertainment systems, satellite terminals, mobile devices, and neural interface endpoints. However, current solutions provide no effective means of securely preserving conversational or contextual continuity across such platforms without remote tracking of user identity, persistent account structures, or cloud-stored memory repositories. The resulting architectures are highly centralized, network dependent, and vulnerable to single points of failure.

Autonomous and semi-autonomous artificial intelligence agents, digital personas, and co-pilot agents face additional continuity challenges not encountered in human-user continuity. Agents may be instantiated concurrently in multiple execution environments, migrated between hardware platforms, rolled back to earlier states, or subjected to state-reconstruction attacks that have no analog in human-user continuity. No existing solution provides persistent operational identity for such agents across heterogeneous execution nodes while also protecting against divergent instantiation, unauthorized duplication, rollback, and state-reconstruction threats.

Prior art in related fields includes wearable-based health monitoring, biometric authentication devices, conversational AI orchestration, distributed transaction platforms, and low-latency communication systems. For example, prior art discloses systems for: wearable body temperature monitoring, health and fitness tracking, biometric authentication, micro-transaction processing in games or chatbots, monetization of user data, latency prediction in gaming, low-latency network optimization, and distributed AI service orchestration. Such systems often depend on cloud-based processing, account-based identity, or centralized server coordination and do not disclose or suggest:
local, non-invertible biometric or interaction-signal-derived continuity tokens generated on a user-associated anchor device;
encrypted continuity memory stored solely under control of that anchor device;
offline restoration of conversational or interactive continuity across heterogeneous interface nodes without cloud-hosted identity profiles or remote memory;
protocol-based, distributed continuity synchronization operating independently of centralized identity directories; and p1 distributed agent continuity management with divergent instantiation detection, hash-chained agent state lineage, and anti-duplication attestation performed locally at an anchor device.

Accordingly, there remains a need for systems and methods capable of enabling seamless continuity of user interaction across diverse interfaces while preserving privacy through local identity derivation, eliminating reliance on persistent cloud identity architectures, enabling offline operational capability, and supporting both biometric and non-biometric continuity for human users and digital agents.

### SUMMARY OF THE INVENTION

The present disclosure provides systems and methods for maintaining persistent continuity of conversational or user-interactive computing sessions across multiple interfaced devices through the use of a continuity anchor device. The continuity anchor device acquires biometric or interaction-derived signals, derives anonymized non-invertible continuity tokens locally without permanent storage or transmission of raw biometric data, and indexes encrypted session context and continuity state data to the derived tokens.

By implementing continuity token derivation, encrypted session storage, and continuity restoration exclusively on the continuity anchor device without reliance on cloud identity services, the present disclosure improves computer system security and reliability, reduces network resource usage, and maintains interactive continuity during network and account outages.

In doing so, the disclosed systems and methods improve the functioning of computer-based interactive platforms by reducing reliance on centralized authentication servers, eliminating single points of failure in session continuity, and enabling secure state restoration even in the absence of network connectivity.

A locally encrypted memory store resident on or controlled by the continuity anchor device retains continuity state, conversational fragments, user preferences, and interaction metadata associated with the token. Upon re-detection of a valid token following interruption events such as disconnection, device handover, lapse of interaction, power cycling, idle periods, or interface transitions, a continuity restoration engine automatically restores session context without requiring network-based authentication, cloud data access, or persistent user account retrieval.

One or more conversational or user-interface nodes implemented across wearable devices, vehicles, robotic platforms, satellite terminals, mobile devices, audiovisual systems, fixed installations, neural interface endpoints, or cloud-hosted conversational systems exchange user-interactive data with the continuity anchor device. These nodes rely on ephemeral continuity token references and do not require persistent storage of personal identity records or biometric data.

The system may operate entirely locally or in decentralized and hybrid configurations, eliminating persistent cloud storage of biometric identifiers or user interaction memory. In certain embodiments, neural-adjacent or physiological activity patterns detected during low-interaction or sleep states may be buffered locally without semantic interpretation and later correlated with waking interactions to provide subtle, non-explicit continuity assistance cues such as prompts or recall reinforcement.

In other embodiments, the system implements a distributed continuity synchronization protocol defining continuity token message formats, cryptographically authenticated handshake sequences, reconciliation rules, and restoration priorities, enabling continuity synchronization across heterogeneous computing platforms and vendor ecosystems without centralized identity directories.

In further embodiments, the continuity architecture is extended to support persistent operational identity for artificial intelligence agents, digital personas, and autonomous entities, including through divergent instantiation detection, anti-duplication attestation, hash-chained agent state lineage with rollback prevention, reconciled continuity domains for multi-agent coordination, and safety-governed agent continuity operations executable fully offline.

### BRIEF DESCRIPTION OF THE DRAWINGS

FIG. 1 illustrates a general system architecture showing a continuity anchor device interacting with multiple user-interface nodes through locally derived continuity tokens.

FIG. 2 illustrates a signal flow diagram depicting biometric or interaction-derived signal acquisition, token derivation, encrypted memory indexing, similarity matching, and continuity restoration across user-interface nodes without cloud dependency.

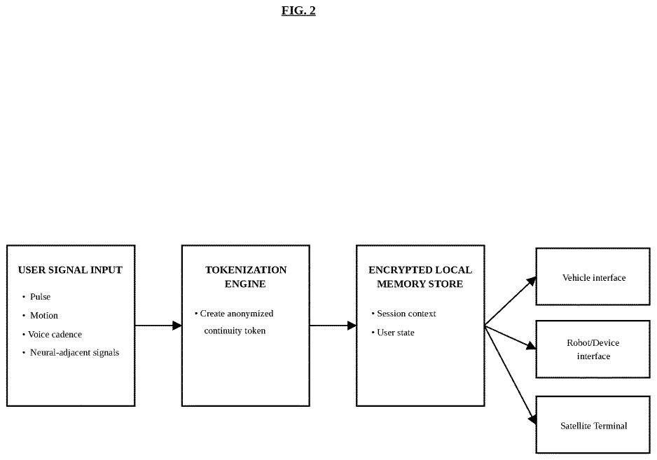

FIG. 3 illustrates an example neural-echo continuity flow showing passive buffering of non-semantic physiological or neural-adjacent signals during sleep or low-interaction states, correlation with waking user interactions, and generation of continuity assistance outputs.

FIG. 4 illustrates an agent continuity token derivation architecture, showing continuity source inputs (digital persona signature, behavioral interaction profile, autonomous agent state fingerprint), tolerance processing within a secure enclave (including normalization, quantization, and optional fuzzy-extractor or secure-sketch operations), combination with a device-specific secret value, and output of a stabilized non-invertible continuity token.

FIG. 5 illustrates a divergent instantiation detection flow, showing comparison of session state metadata received from two or more agent execution nodes against a session state registry maintained within secure enclave or trusted execution hardware, and conditional denial of continuity restoration upon detection of a divergent instantiation condition.

FIG. 6 illustrates a hash-chained agent state lineage and rollback prevention structure, showing successive state lineage entries each comprising a state sequence number, state-payload hash, hash-chain link to the prior entry, commit timestamp, and digital signature produced by key material resident within the secure enclave.

FIG. 7 illustrates an attestation and proof-of-custody reinstantiation flow, showing presentation by an agent execution node of a hardware-bound credential, attestation token, or proof of custody, anchor-local verification within the secure enclave, and conditional authorization or denial of agent reinstantiation.

FIG. 8 illustrates a reconciled continuity domain structure, showing multiple agents indexed by respective continuity tokens, a shared state payload, per-member access control records, and a domain state lineage maintained locally by the continuity anchor device without participation of any centralized coordinator.

### DETAILED DESCRIPTION OF EMBODIMENTS

The present disclosure provides a technological improvement to privacy-preserving session continuity systems by enabling secure cross-device state restoration without reliance on remote identity servers or persistent biometric storage.

### 6.0 Definitions

As used herein:
“Continuity token” refers to a non-invertible cryptographic value derived from one or more biometric or interaction-derived signals of a user (or digital persona) and a device-specific or environment-specific secret value, and used solely to index locally encrypted continuity state data without storing or transmitting raw biometric measurements.
“Neural-adjacent” signal denotes any physiological or electrical measurement obtained from a sensor positioned proximate to, but not penetrating, the user's skin or skull and processed only as numerical time-series data and statistical pattern signals, explicitly excluding any decoding or determination of specific thoughts, memories, or semantic mental content, and excluding any diagnosis or treatment of medical or mental health conditions.
“Non-semantic interpretation” means statistical or spectral analysis only-no word, memory, intent, or concept is extracted from the signals.
“Memory enhancement signal” refers to a non-verbal output, such as a vibration pattern, tone sequence, light signal, or brief cue, designed to reinforce recall without semantic content.
“Reflection pause” refers to a 0.5-3 second delay in response timing introduced by the system to simulate human thoughtfulness or deliberation.
“Continuity confidence threshold” refers to an acceptance metric, including but not limited to Hamming distance values, probabilistic similarity scoring, or vector distance calculations, used to determine whether two continuity tokens sufficiently correspond to authorize restoration of session context.
“Neural interface signal sensor” refers to any sensor capable of non-invasive acquisition of electrophysiological, electro-dermal, or neural-adjacent signals positioned proximate to the skin or cranial surface without penetrating tissue.
“Local authorization register” refers to a secure, device-resident memory record restricting continuity restoration or enhanced feature access to time-delimited intervals or specific usage conditions upon satisfaction of local cryptographic or biometric authorization conditions.
“Safety governance layer” refers to a software, firmware, or hardware module configured to monitor biometric indicators, user consent, and device tamper conditions and to control memory storage, erasure, authorization state, and continuity restoration according to predefined safety and privacy rules.
“Behavioral modulation engine” refers to a processing module configured to adapt system response timing, interaction cadence, or presentation characteristics based on biometric or interaction-derived measurements to better align with user behavior or preferences.
“Docking interface” refers to a physical and/or electrical interface configured to provide secure, time-limited communication between the continuity anchor device and an external device or station for authentication, diagnostics, firmware updating, or controlled data access.
“Continuity anchor device” refers to a user-associated computing device or secure virtual environment configured to acquire biometric or interaction-derived signals from a user or digital persona and locally execute continuity token derivation, encrypted memory indexing, similarity matching, continuity restoration, cryptographic authorization, and safety-governance operations, the continuity anchor device being implemented in some embodiments as a wearable computing device and in other embodiments as a mobile terminal, headset, vehicle-integrated module, robotic interface node, neural interface endpoint, trusted execution environment, or other user-associated computing platform.
“Non-transitory computer-readable medium” refers to any non-transitory data storage device, including but not limited to random-access memory (RAM), read-only memory (ROM), flash memory, magnetic storage media, or optical disks, and explicitly excludes transitory propagating signals or carrier waves.

### 6.1 System Architecture

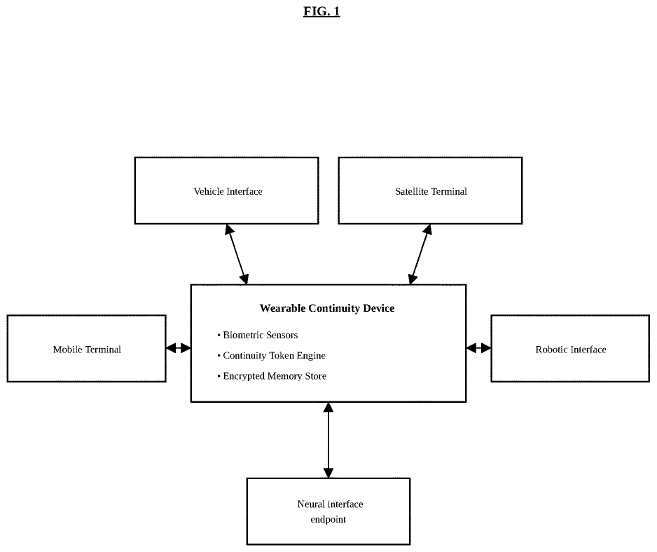

As shown in FIG. 1, the system comprises a continuity anchor device associated with a user. In many embodiments, the continuity anchor device is implemented as a wearable device such as a pendant, bracelet, ring, or head-mounted unit. In other embodiments, the continuity anchor device is implemented as a mobile terminal, vehicle-integrated console, neural interface gateway, robotic node, or other form factor.

The continuity anchor device includes one or more biometric or interaction-derived sensors, such as:
pulse or heart rate sensors;
thermal or skin temperature sensors;
inertial measurement units, accelerometers, or gyroscopes;
electro-dermal or galvanic skin response sensors;
neural-adjacent electrophysiological sensors;
microphones or vocal cadence analyzers;
capacitive, touch, or typing rhythm sensors;
gaze, motion, or additional interaction pattern detectors.

The continuity anchor device executes an identity derivation engine that processes raw sensor data locally to generate a continuity token. This token represents an anonymized biometric or interaction profile. Raw biometric identifiers and feature vectors need not be stored in non-volatile memory, nor transmitted outside the continuity anchor device.

A locally encrypted memory store within or under the control of the continuity anchor device indexes conversational state, session context, user preferences, conversation history fragments, continuity metadata, or other user-interactive information to the continuity token. The encrypted memory store may be implemented using symmetric or asymmetric cryptography and may rely on secure enclaves or trusted execution hardware.

Example: In a vehicular use case, the continuity anchor device (worn as a pendant or integrated into the steering column) detects pulse and motion signals while the user is driving, derives a continuity token, and stores a conversation about navigation preferences, calendar entries, and entertainment selections keyed to the token. Upon the user's arrival home, the same continuity anchor device interacts with a domestic robotic system; the robotic system receives continuity cues from the anchor device and restores the preferences and conversation context seamlessly.

### 6.2 Continuity Restoration

Upon reconnection of the continuity anchor device to any conversational user-interface node, the identity derivation engine acquires fresh biometric or interaction-derived signals and determines whether a previously derived continuity token has been re-detected following one or more interruption events, including:
device transitions;
Power Loss or Reboot;
network interruptions;
idle periods or lapse of user interaction;
removal and re-association of the continuity anchor device with the user.

Upon successful token recognition, the continuity restoration engine retrieves associated session state and re-establishes the contextual conversational environment without requiring network authentication, credential entry, or cloud retrieval of stored memory. Restoration may include resuming a prior dialog, reinstating user-specific preferences, or reconstituting the last known interaction state.

Example: After a two-hour idle period, the continuity anchor device re-detects the continuity token upon sensing a valid live-user biometric pattern and restores a conversation on a mobile terminal, optionally adjusting response latency to match the user's recent typing rhythm.

### 6.3conversational User-Interface Nodes

As shown in FIG. 1, conversational user-interface nodes may operate on any computing platform capable of exchanging user-interactive data with the continuity anchor device, including but not limited to:
wearable devices;
vehicles and autonomous transport platforms;
robotic systems or assistive robotics;
mobile terminals or phones;
fixed installations, kiosks, or retail terminals;
entertainment systems or audiovisual terminals;
satellite communication terminals or spacecraft consoles;
head-mounted displays or spatial projection systems;

neural interface endpoints;
cloud-hosted conversational or AI services.

These nodes do not persist long-term personal identity data and rely solely on ephemeral continuity tokens or token references exchanged locally with the continuity anchor device to obtain continuity context. Session data may be streamed from the continuity anchor device or reconstructed based on state information supplied by the continuity anchor device.

Example: In a vehicle-to-robot transition, the continuity anchor device hands off an ongoing conversation about daily tasks from the car's infotainment system to a home robotic assistant without transmitting raw biometric data to either system.

### 6.4 Token Derivation and Encryption

The continuity token is generated using local cryptographic derivation mechanisms incorporating:
biometric or interaction signal preprocessing and normalization;
statistical entropy quantization or feature extraction;
rolling feature vector construction over sliding windows;
cryptographic hashing functions, such as SHA-256 or similar primitives.

Tokens are transient, revocable, and non-invertible, ensuring that personally identifiable biometric or neural signals cannot be reconstructed from the stored continuity data. The continuity anchor device may rotate or refresh continuity tokens periodically or in response to security events.

The encrypted memory store uses symmetric or asymmetric cryptographic encryption to prevent unauthorized extraction of session or identity contextual data. Neither raw biometric data nor full feature vectors are stored in non-volatile memory or transmitted externally. In some embodiments, only truncated token indices and encrypted session payloads are stored.

### 6.4.1 Example Token Generation Algorithm

In one embodiment, the identity derivation engine samples pulse rate and motion data at predetermined sampling frequencies. Pulse rate is sampled at 32-128 Hz and motion from a three-axis accelerometer is sampled at 50-200 Hz. The engine computes, over a sliding time window of 5-20 seconds, a biometric feature vector comprising at least:
(i) an average pulse rate;
(ii) a pulse rate variance;
(iii) an average acceleration magnitude; and
(iv) an acceleration variance.

Each feature is normalized into a bounded numeric range and quantized into a fixed number of bits (for example, 8-12 bits per dimension). The quantized values are concatenated into a feature string and combined with a device-specific secret value stored in a secure enclave. A cryptographic hashing function, such as SHA-256, is applied to the concatenated feature string and device secret to produce a digest. A subset of the digest bits (for example, 128 bits) is used as the continuity token. The token is non-invertible with respect to the underlying biometric measurements.

### 6.4.1.1 Worked Example—Continuity Token Generation and Matching

In one illustrative example:
A pulse sensor reports heart rate samples with an average of 72.4 bpm and variance of 4.1.
A three-axis accelerometer reports motion magnitudes averaging 0.032 g with variance of 0.009.

The identity derivation engine forms a feature vector F=[72.4, 4.1, 0.032, 0.009] and normalizes it to a bounded interval, yielding F′. Each component is quantized into fixed-bit integer representation Q. The quantized values are concatenated into a feature string S. S is concatenated with a device-specific secret D stored in a secure enclave, resulting in X.

A cryptographic hash H=SHA256(X) is computed, and a predetermined subset of bits is truncated to produce the continuity token T. Upon subsequent operation, new biometric samples produce a re-derived vector yielding a second token T′. A token comparison module computes the Hamming distance HD(T, T′) between T and T′. If HD(T, T′) is less than or equal to a threshold (e.g., 10 bits out of 128 bits), the tokens are considered matched and the continuity confidence threshold is satisfied. The indexed continuity state data may then be retrieved from the encrypted local memory store to restore the user session. If the threshold is not satisfied, continuity restoration is denied.

This process ensures robustness to transient biometric fluctuations while preventing reconstruction of underlying biometric measurements from the continuity token.

In informal prototype testing conducted entirely offline using pulse-rate and motion-derived signals, the continuity token system consistently exceeded a same-user matching rate of zero point nine five across repeated sessions, with low false acceptance, without reliance on any network connectivity or centralized identity service.

### 6.4.2 Example Token Matching

When a new continuity token is generated, a token comparison module computes a similarity metric between the new token and one or more previously stored reference tokens. In one embodiment, the similarity metric is a Hamming distance between token bit strings. In other embodiments, similarity may be computed using correlation coefficients, Euclidean or cosine distance in an embedding space, or probabilistic matching.

If the similarity metric between the new token and a stored reference token satisfies the continuity confidence threshold, the system treats the tokens as a match and authorizes retrieval of associated session context. If the similarity metric does not satisfy the threshold for any stored token, continuity restoration is denied, and no session context is loaded.

### 6.4.3 Continuity State Machine Operation

In some embodiments, continuity management is performed using a multi-state execution model. The system operates according to the following states:
Enrollment State—the continuity anchor device acquires biometric or interaction-derived signals and generates an initial continuity token associated with a new encrypted session memory entry.
Active Continuity State—the system continuously refreshes token derivation for ongoing session verification and may update encrypted session context incrementally.
Matching State—upon reconnection, idle interruption, or interface transition, the continuity anchor device computes a re-derived continuity token and compares it to stored tokens using similarity metrics.
Authorization State—if confidence thresholds are met, associated session context is restored or partially restored.
Revocation State—if mismatch or tamper detection occurs, the associated continuity token and its indexed memory state are invalidated and optionally erased.
Re-Enrollment State—upon user consent or security reset, new continuity tokens are generated and continuity resumes.

This state-machine logic is executed locally on the continuity anchor device without reliance on centralized servers or cloud identity services.

A Pseudocode Representation:

```
WHILE system_active:
  SAMPLES ← acquire_sensor_window( )
  F ← normalize_features(SAMPLES)
  Q ← quantize(F)
  X ← concat(Q, device_secret)
  TOKEN_new ← hash(X)
  IF stored_tokens empty THEN
    store(TOKEN_new, session_state)
    state ← ACTIVE
  ELSE
    match_found ← FALSE
    FOR each TOKEN_old in stored_tokens:
      IF HAMMING(TOKEN_new, TOKEN_old) <= threshold THEN
        restore_session(TOKEN_old)
        state ← AUTHORIZED
        match_found ← TRUE
        BREAK
    IF NOT match_found THEN
      deny_continuity( )
      state ← REVOKE
END WHILE
```

### 6.5 Offline Operation

The continuity anchor device and user-interface nodes may function independently of persistent network connectivity. All continuity restoration operations can be executed locally or via direct device-to-device communication mechanisms without cloud dependency.

The system can operate indefinitely in offline mode while still providing continuity restoration based solely on locally stored tokens and encrypted memory. Continuity assistance cues, such as subtle prompts or memory reinforcement signals, do not generate any persistent data outside the continuity anchor device, reinforcing privacy guarantees.

Example: In a remote area without network coverage, the continuity anchor device restores a session from local memory upon reboot and resumes interaction with a nearby offline terminal. 6.6 Additional Embodiments—Cognitive Continuity and Liveness Verification

### 6.6.1 Neural Echo/Passive Cognitive Continuity

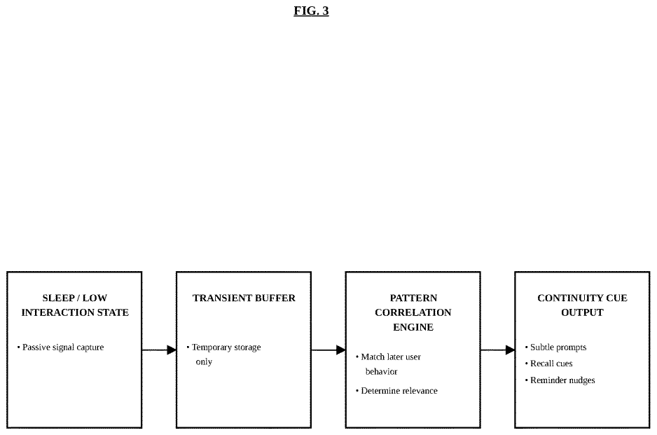

In some embodiments illustrated in FIG. 3, the continuity anchor device may passively detect non-semantic physiological or neural-adjacent signal patterns during periods of reduced interaction or sleep states.

Such signals are:
temporarily buffered in local volatile memory;
summarized into non-semantic statistical measures;
not semantically interpreted or decoded;
not transmitted to any remote system.

Upon subsequent waking interactions, current user activity patterns may be correlated with buffered activity signatures to determine potential contextual relevance. When a correlation threshold is satisfied, the system may generate non-explicit continuity assistance outputs selected from:
subtle prompts;
recall-reinforcement cues;
memory enhancement signals;
nudge notifications.

These outputs do not constitute interpretation of dream content or direct decoding of user thoughts, but serve solely to reinforce continuity between subconscious activity and waking task completion.

In one embodiment, the continuity anchor device samples physiological signals such as heart rate variability and skin conductance at a low sampling frequency (e.g., 0.5-4 Hz) during periods when the user is detected as inactive or sleeping. The sampled values are stored in a circular buffer representing a rolling time window (e.g., 30-90 minutes) and are periodically summarized into numerical statistics. Upon detection of waking interaction, the system computes similarity metrics between the summarized physiological statistics and recent interaction patterns; if a threshold level of correlation is detected, the system triggers a predetermined cue pattern (such as a brief vibration or tone) associated with a previously stored task reminder.

At no point are the buffered physiological signals transformed into decoded semantic content or used for medical analysis.

### 6.6.2 Liveness and Anti-Spoofing Verification

In some embodiments, the continuity anchor device applies liveness validation to ensure continuity authorization is based on genuine live-user biometric sampling rather than spoof replication. Liveness measures may include:
challenge-response testing of pulse-rate variability over randomized sampling windows;
sensor fusion cross-validation between pulse, motion, thermal, and electro-dermal signals to detect physiological coherence;
detection of temporal anomalies inconsistent with continuous biological signal generation;
detection of static or replayed signal patterns indicative of recording attacks.

If spoofing or replay patterns are detected, continuity matching is denied, revocation protocols are initiated, and memory entries may be invalidated or erased according to safety policies.

### 6.7 Privacy and Data Control

No personally identifiable biometric data, raw neural recordings, dream content, or unprocessed sensor streams are stored permanently or transmitted externally. All continuity tokens, buffers, memory indexing, and continuity restoration operations are executed locally under control of the continuity anchor device.

User memory may be selectively retained, erased, or purged based on user preferences, inactivity thresholds, or regulatory requirements. No cloud-based biometric identity storage or centralized session continuity servers are required.

### 6.8 Security and Tamper Protection

The continuity anchor device can include tamper detection circuits, encrypted secure enclaves, write-once memory fusing mechanisms, and hardware integrity checks configured to trigger cryptographic erasure of stored continuity keys, encrypted memory data, and associated continuity tokens upon detection of unauthorized access attempts or tampering.

In docking-enabled embodiments, any external docking station or host device participating in controlled data access is further configured to cryptographically erase temporary session keys, cached continuity data, and authentication credentials upon termination of the session, ensuring that no user memory, continuity state, or biometric-derived data remains accessible outside the continuity anchor device. All such security and tamper protection operations are executed locally and do not depend on network connectivity or cloud services.

### 6.9 Commercial and Software Integration

The system may operate with local transaction authorization mechanisms in which micro-transaction or local access triggers initiate temporary enhanced continuity features or session privileges without dependency on centralized accounts, remote identity servers, or cloud-based validation. In payment-enabled embodiments, the continuity anchor device generates transaction authorization requests, verifies cryptographic receipts or zero-knowledge proofs, and updates a local time-locked authorization register.

Transactions are generated, validated, and recorded locally. Authorization updates are written exclusively to the local authorization register tied to the continuity token. Variable transaction parameters may include session duration, feature access, or other operational enhancements defined by local policy modules. No raw biometric data, detailed continuity state, or network-based identity information is transmitted externally for monetization. Transactions do not rely on network communication for validation, supporting fully offline operation.

Reflection pauses between 0.5 and 3 seconds may be applied to responses to simulate human thoughtfulness, enhance perceived quality, and avoid masking latency. These local transaction authorization mechanisms function independently of biometric identity derivation and remain subordinate to the privacy and safety protections described herein.

### 6.9.1 Micro-Transaction Validation Protocol

In embodiments supporting micro-transactions or local access unlocks, the transaction-based access control module executes a cryptographic validation protocol independent of cloud identity systems. A representative flow includes:
Step A: The continuity anchor device generates a locally issued transaction request containing a time stamp, session continuity token hash reference, feature unlock identifier, and transaction request parameters based on local policy.
Step B: A local or optionally connected payment processing subsystem returns a cryptographic payment confirmation receipt including a transaction validation signature or proof.
Step C: The continuity anchor device validates the receipt using signature verification or zero-knowledge proof techniques without exposure of raw biometric data or full continuity tokens.
Step D: Upon validation, the continuity restoration engine updates a local time-locked authorization register to permit enhanced session functionality or extended access intervals.
Step E: All transaction generation, validation, and authorization operations are executed locally; no continuity state, raw biometric data, or user memory is transmitted externally.

### 6.10 Clinical Disclaimer

The disclosed system does not provide medical diagnosis, mental health evaluation, dream interpretation, or neural therapeutic treatment. Neural-adjacent detection serves only as a passive contextual continuity support mechanism and does not decode neurological content or cognitive intent.

### 6.11 Policy-Adaptive Continuity Operation

In certain embodiments, the biometric continuity token system applies one or more jurisdictional, enterprise, or regulatory policy profiles that dynamically govern the operation of continuity token processing, session state retention, authorization verification, or metadata disclosure behaviors.

Policy profiles may specify that continuity operations execute in one or more selectable compliance modes including:
a) a fully private local-operation mode in which continuity tokens and session memory are generated, stored, matched, and erased exclusively on the continuity anchor device without any external reporting of continuity state or metadata;
b) a regulated compliance mode in which a subset of cryptographically verifiable session metadata or authorization records are escrowed, encrypted, or transmitted to a designated compliance validation endpoint without exposure of raw biometric signals, neural-adjacent signals, or personal interaction content; and
c) a hybrid operation mode in which token derivation and session continuity remain local while authorization or audit confirmation receipts are periodically synchronized to compliance infrastructure systems according to jurisdictional or enterprise rules.

Selection or switching of policy profiles may be configured automatically based on device geolocation, regulatory instruction broadcasts, enterprise security directives, or user-authorized overrides. In all cases, the continuity token derivation, encrypted memory indexing, similarity-matching algorithms, and restoration logic remain locally executed on the continuity anchor device, ensuring that core continuity capabilities operate independently of centralized identity control.

### 6.12 Protocol-Based Continuity Synchronization

In certain embodiments, the system implements a distributed continuity synchronization protocol defining structured message formats, cryptographic continuity identifiers, handshake sequences, reconciliation rules, and state restoration ordering logic for transferring and synchronizing user or agent interaction context across heterogeneous computing platforms.

The protocol governs:
transmission of continuity token references or cryptographic hashes between user-interface nodes and the continuity anchor device;
cryptographically authenticated session-state reconciliation requests and acknowledgments;
conflict resolution handling between partial or concurrent interaction streams originating from different interface nodes;
session restoration staging for continuation of conversational flow following device transitions or network interruptions.

The protocol operates independently of any single interface platform and may be implemented within hardware, firmware, software applications, or virtualized environments across devices operated by differing vendor ecosystems or ownership domains. Protocol execution does not require shared persistent user accounts or centralized identity directories.

### 6.13 Digital Persona and Autonomous Agent Continuity

In certain embodiments, continuity tokens may be derived not only from biometric or interaction-derived human signal sources but additionally from digital persona signatures, behavioral interaction profiles, or autonomous agent state fingerprints representing persistent conversational or operational identities of non-human or semi-autonomous entities.

Accordingly, the continuity system supports session continuity not only between computing platforms associated with human users, but also between interacting digital agents, co-piloting assistants, virtual personas, or neural-simulation-derived identity constructs wherein continuity identification is established via cryptographically derived interaction-state signatures rather than biological anchoring.

The encrypted memory indexing and continuity restoration engines process such persona-derived continuity tokens using the same similarity metrics and threshold confidence mechanisms to preserve persistent conversational context across computing platforms for both human and non-human identity entities.

### 6.14 Hardware-Neutral Anchor Implementations

In certain embodiments, the continuity anchor device may be implemented as a physical wearable apparatus, mobile terminal, implanted computing module, vehicle-integrated computing environment, robotic subsystem node, neural interface gateway, distributed trusted execution container, or fully virtualized cryptographic persona environment.

Such implementations encompass both dedicated hardware anchors and software-instantiated anchors operating within secure enclaves, trusted execution environments, containerized compute nodes, peer-to-peer mesh routers, or ledger-bound cryptographic entities. In all embodiments, the continuity token generation, encrypted memory indexing, similarity matching, authorization updating, and restoration logic remain functionally equivalent, independent of physical or virtual embodiment.

### 6.15 Distributed Agent Continuity Architecture

In certain embodiments, the continuity architecture described herein is extended to maintain persistent operational identity of one or more artificial intelligence agents across heterogeneous execution environments. As used herein, “persistent operational identity” refers to a restorable set of operational state parameters—including, without limitation, personality parameter profiles, behavioral preference vectors, interaction cadence parameters, constraint matrices, privilege parameters, and state lineage records as defined in this Section 6.15—sufficient to resume agent behavior at a point of interruption without re-initialization. In such embodiments, the continuity anchor device is configured not only to preserve continuity for human users but also to preserve continuity for non-human computational entities including artificial intelligence agents, digital personas, co-pilot agents, autonomous software agents, and hybrid human-agent operational constructs. The subsections of this Section 6.15 extend, particularize, and add detailed embodiments for agent continuity, addressing failure modes and operational requirements that may arise in agent-based continuity, including failure modes in which an agent may be instantiated concurrently in multiple execution environments, migrated between hardware platforms, rolled back to earlier states, or subjected to state-reconstruction attacks.

As used in this Section 6.15, an “agent execution node” refers to any computing environment on which operation of an artificial intelligence agent may be instantiated, resumed, migrated, or continued, including without limitation cloud inference nodes, personal computing systems, mobile devices, embedded robotics processors, vehicular automation modules, satellite-linked terminals, decentralized compute peers, edge-processing devices, and fixed installations. As used in this Section 6.15, “agent continuity state data” refers to encrypted locally indexed state information sufficient to preserve operational identity of an artificial intelligence agent across time or across execution environments, including without limitation personality parameter profiles, behavioral preference vectors, interaction cadence parameters, constraint matrices, privilege parameters, execution thresholds, resource allocations, entitlement states, task-priority data, tool-usage patterns, interaction-style parameters, safety-condition data, or encrypted continuity fragments sufficient to resume operation at a point of interruption.

### 6.15.1 Agent Continuity Token Derivation

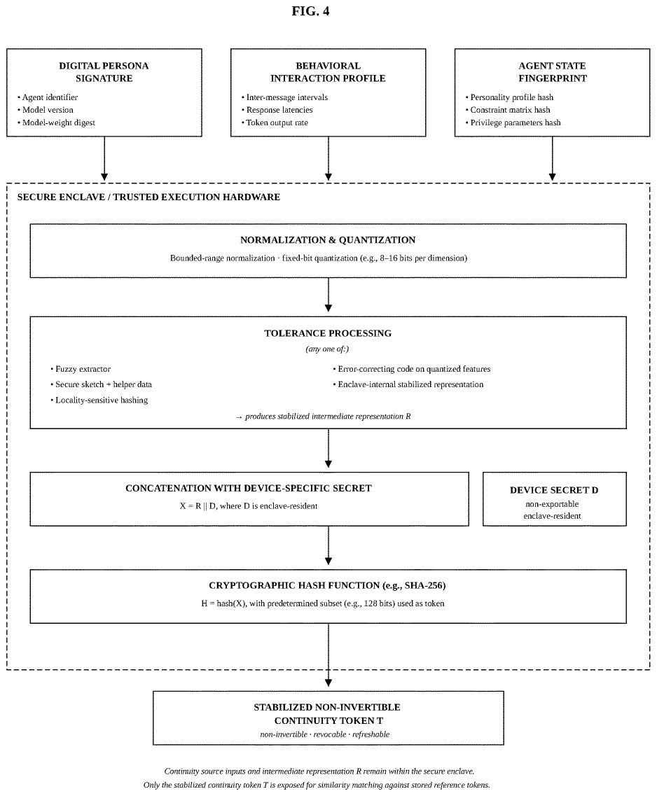

In certain embodiments illustrated in FIG. 4, the identity derivation engine derives a non-invertible continuity token for an artificial intelligence agent from one or more continuity source inputs associated with that agent. Continuity source inputs may include, without limitation: a digital persona signature associated with the agent; a behavioral interaction profile derived from prior agent activity; an autonomous agent state fingerprint; response latency patterns; token output rate or output cadence characteristics; session initiation cadence; tool invocation sequences; interaction-state hashes; prompt-response timing distributions; execution-graph features; or cryptographically derived summaries of recent agent behavior.

A digital persona signature, in one embodiment, may be computed as a cryptographic hash of a concatenation of: (i) an agent identifier unique within a scope defined by the continuity anchor device; (ii) a version identifier for the agent's underlying model or configuration; (iii) a model-weight digest comprising a cryptographic hash of persistent model parameters or a representative subset thereof; and (iv) a creation-epoch timestamp. In a representative non-limiting example, the digital persona signature is computed as the SHA-256 hash of the concatenation of these four elements, producing a 256-bit value of which a predetermined subset (for example, 128 bits) is used as the persona signature input to continuity token derivation.

A behavioral interaction profile, in one embodiment, may be a fixed-length numerical vector summarizing the agent's observed interaction patterns over a sliding time window. Typical time windows may range, for example, from 30 minutes to 7 days. The vector may comprise, without limitation: a mean inter-message interval; a standard deviation of inter-message intervals; a mean response generation latency; a token output rate measured in tokens per second; a mean session-initiation cadence measured in sessions per hour; and a turn-length distribution summary. Each value may be normalized into a bounded numeric range and quantized into a fixed number of bits (for example, 8 to 16 bits per dimension).

An autonomous agent state fingerprint, in one embodiment, may be a cryptographic derivative of the agent's current operational state, computed as a cryptographic hash of a concatenation of: (i) a hash of the current active personality parameter profile; (ii) a hash of the current active constraint matrix; (iii) a hash of the current active privilege parameters; and (iv) the current value of a monotonically incrementing state sequence number maintained by the continuity anchor device.

The selected continuity source inputs are normalized, quantized, transformed, encoded, hashed, or otherwise processed together with a device-specific or environment-specific secret value retained locally by the continuity anchor device to produce the non-invertible continuity token. The device-specific or environment-specific secret value may be stored within secure enclaves or trusted execution hardware of the continuity anchor device. The resulting continuity token is revocable, refreshable, and non-invertible with respect to the underlying continuity source inputs.

In some embodiments, the continuity token may function as a fuzzy continuity index rather than as an exact-match authentication credential. Continuity restoration may be authorized when similarity between a newly derived token and a stored reference token satisfies a predefined continuity confidence threshold, rather than only when exact token equality is present. Similarity may be evaluated using one or more metrics including Hamming distance, Euclidean distance, cosine distance, probabilistic confidence scoring, correlation-based scoring, or combinations thereof.

In embodiments requiring tolerance to bounded variation in the continuity source inputs, similarity evaluation may be performed prior to final cryptographic token commitment, within the secure enclave or trusted execution hardware, on stabilized intermediate representations of the continuity source inputs. Such stabilized intermediate representations may be produced by one or more of: a fuzzy extractor; a secure sketch combined with helper data and cryptographic re-hashing; a locality-sensitive hashing function applied to the normalized and quantized feature vector; an error-correcting code applied to a quantized feature representation in combination with stored helper data; or an enclave-internal stabilized feature representation derived from the normalized and quantized continuity source inputs. In such embodiments, the cryptographic continuity token represents a stabilized output produced after such tolerance processing, rather than a raw output of a cryptographic hash applied directly to unstable behavioral or state-derived inputs. In other embodiments, the similarity metric may be applied directly to the normalized and quantized feature representations of the continuity source inputs, with a final cryptographic hash applied only after a successful similarity match has been determined within the secure enclave or trusted execution hardware. These embodiments collectively avoid reliance on similarity comparisons performed solely on the avalanche output of an unmodified cryptographic hash function applied to slightly varying source inputs.

In a representative non-limiting example consistent with the foregoing tolerance-processing embodiments, a behavioral interaction profile vector V=[120.3, 14.7, 420, 38.2, 4.6, 87.1] may be produced representing six characteristic dimensions. V is normalized and quantized into a feature string S. A digital persona signature P is computed as SHA-256 of a concatenation of the agent identifier, model version, model-weight digest, and creation timestamp. An agent state fingerprint F is computed as SHA-256 of the concatenation of hashes of the active personality parameter profile, constraint matrix, and privilege parameters with the current state sequence number. A stabilized intermediate representation R is produced from S, P, and F using one or more of the tolerance-processing techniques described above (such as application of a secure sketch with helper data, locality-sensitive hashing of the quantized feature representation, or enclave-internal feature stabilization). The concatenation R∥D (where D is the device-specific secret value) is computed and SHA-256 applied, producing a 256-bit digest from which the first 128 bits may form the agent continuity token T. A subsequent redetermination using the same tolerance-processing path produces T′. A Hamming distance HD(T, T′) less than or equal to a predetermined threshold (for example, 12 bits out of 128 bits) satisfies the continuity confidence threshold. Alternatively, the similarity metric may be evaluated within the secure enclave on the stabilized intermediate representations R and R′ directly, with the cryptographic token derived only following successful intermediate-level matching.

### 6.15.2 Agent Continuity State Data Taxonomy and Local Control

In certain embodiments, encrypted agent continuity state data is stored in a locally encrypted memory store of the continuity anchor device indexed to one or more continuity tokens. The agent continuity state data may represent persistent operational identity attributes of the artificial intelligence agent and may be sufficient to restore, resume, or continue operation of the agent following interruption, migration, or reinstantiation. The data categories described in this subsection are representative and non-limiting; combinations and sub-selections of these categories may be used.

A personality parameter profile, in one embodiment, may comprise one or more named parameters characterizing the operational personality of an artificial intelligence agent, including without limitation: a response tone parameter specified as a numerical value within a bounded range or as a categorical value selected from a predefined set; a verbosity parameter specified as a target response length range in tokens, words, or characters; a formality parameter specified as a numerical value within a bounded range; an assertiveness parameter specified as a numerical value within a bounded range; and additional parameters such as humor tolerance, empathy-weighting, or domain-preference weights characterizing response generation behavior.

A behavioral preference vector, in one embodiment, may be a fixed-length numerical vector comprising floating-point values representing the agent's preferences across one or more operational dimensions. In one representative non-limiting embodiment, a behavioral preference vector may comprise a sixteen-dimensional or thirty-two-dimensional vector in which each dimension corresponds to a predefined operational preference axis and each value is a normalized floating-point number in a bounded range. In alternative embodiments, the vector dimensionality may range, for example, from eight to one thousand twenty-four dimensions depending on the complexity of the agent.

An interaction cadence parameter, in one embodiment, may be a numerical value or set of values characterizing the temporal rhythm of the agent's interaction. In one representative non-limiting embodiment, interaction cadence parameters may comprise: a mean inter-message interval measured in seconds; an inter-message interval standard deviation measured in seconds; a typical response latency measured in milliseconds; and a turn-length distribution characterizing the average and variance of agent response lengths.

A constraint matrix, in one embodiment, may be a two-dimensional matrix of values specifying operational constraints applicable to the agent. In one representative non-limiting embodiment, the constraint matrix may comprise rows corresponding to named constraint categories including without limitation content-safety constraints, resource-usage constraints, domain-access constraints, and user-interaction constraints, and columns corresponding to constraint attributes including without limitation enabled/disabled state, threshold value, enforcement action, and override-required flag. In a further representative non-limiting embodiment, the constraint matrix may be implemented as a sixteen-by-four integer matrix in which rows correspond to sixteen predefined constraint categories and columns correspond to four constraint attributes. Privilege parameters, in one embodiment, may comprise a data structure specifying resource allocations, delegated permissions, execution thresholds, or entitlement states associated with the agent, including without limitation: a maximum memory allocation specified in megabytes; a maximum processing quota specified as a fraction of available compute resources or as a time-limited allocation; a set of delegated permission identifiers, each referring to a predefined permission category; execution thresholds specifying maximum session durations, maximum request rates, or maximum concurrent operations; and entitlement state flags indicating whether specific enhanced features are currently authorized.

In some embodiments, the locally encrypted memory store contains only encrypted state fragments indexed to the continuity token, such that raw behavioral parameters, plaintext constraint matrices, plaintext privilege parameters, or other sensitive continuity state values are not persistently stored in plaintext and are not transmitted externally absent local authorization.

Restoration of agent continuity state from the encrypted state fragments may require locally retained cryptographic key material under control of the continuity anchor device. The continuity anchor device may provide agent continuity state to one or more agent execution nodes only in forms that are insufficient by themselves to reconstruct full agent operational identity absent locally controlled cryptographic authorization.

### 6.15.3 Divergent Instantiation Detection and Anti-Duplication Safeguards

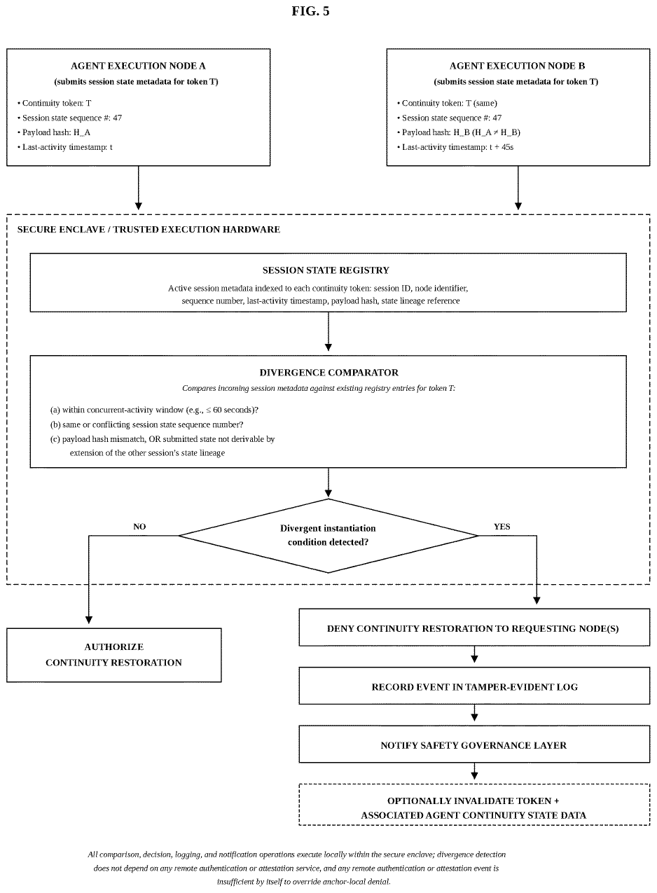

In certain embodiments illustrated in FIG. 5, the continuity anchor device is configured to detect unauthorized duplication, divergent reinstantiation, or conflicting concurrent operation of an artificial intelligence agent, and to deny continuity restoration upon detection of such a condition. A divergent instantiation condition may be determined to exist in any of the following representative non-limiting scenarios:
Scenario (i)—detection of concurrent active agent sessions indexed to the same continuity token and originating from two or more agent execution nodes, where the session state metadata associated with the two or more sessions is inconsistent;
Scenario (ii)—presentation of inconsistent session-state metadata from multiple execution nodes for the same continuity token within a predetermined concurrent-activity window;
Scenario (iii)—attempted restoration of the same continuity token in mutually inconsistent execution contexts;
Scenario (iv)—attempted reconstruction of full agent continuity state from duplicated or stale continuity fragments; and
Scenario (v)—presentation of conflicting privilege, entitlement, or execution-threshold data associated with a common continuity token.

Session state metadata for each active agent session may comprise: a session identifier uniquely identifying the session within the scope of the continuity anchor device; the identity of the agent execution node on which the session is running, which may be established by cryptographic attestation where available or by a node identifier provided by the execution node; a monotonically incrementing session state sequence number maintained for the session; a last-activity timestamp; and a hash of the most recently committed session state payload.

The continuity anchor device may maintain a session state registry within the secure enclave or trusted execution hardware. Upon receiving a continuity state synchronization message from an agent execution node, the continuity anchor device may compare the session state metadata of the submitted session against the session state metadata of any other currently active session indexed to the same continuity token. In one embodiment, a divergent instantiation condition may be determined to exist when, for two or more active sessions indexed to the same continuity token: both sessions have last-activity timestamps within a predetermined concurrent-activity window (for example, 60 seconds to 15 minutes); and the most recently committed session state payload hash of one session cannot be derived by extension of the state lineage of the other session, indicating that the two sessions have forked from a common ancestor state and evolved divergently rather than one session being a continuation of the other.

Upon detection of a divergent instantiation condition, the continuity anchor device may: deny continuity restoration to any agent execution node presenting the affected continuity token; record a divergent instantiation event in a local tamper-evident event log; optionally invalidate the continuity token and the associated encrypted agent continuity state data, requiring re-enrollment before further agent continuity is possible; and optionally notify the safety governance layer, which may initiate cryptographic erasure or impose additional restoration constraints.

In a representative non-limiting example, an agent execution node A at time t reports a session with session sequence number 47 and payload hash H_A to the continuity anchor device. An agent execution node B, at time t+45 seconds, reports a session indexed to the same continuity token with session sequence number 47 and payload hash H_B, where H_B is not equal to H_A. The continuity anchor device may determine that both sessions are within the 60-second concurrent-activity window, that both report the same session sequence number, and that the payload hashes differ-establishing a divergent instantiation condition. The device may then deny restoration to node B, record the event, and notify the safety governance layer.

The continuity anchor device may further enforce anti-duplication safeguards independently of or in combination with divergent instantiation detection by conditioning restoration on local validation of a cryptographic credential, attestation token, or proof of custody of agent continuity state that is cryptographically bound to the continuity token and verified by the continuity anchor device using locally stored cryptographic key material. Restoration may be denied to any agent execution node that cannot present a valid credential bound to the continuity token. In some embodiments, each agent execution node may be treated as untrusted with respect to continuity token validation and agent continuity state authorization, and the continuity anchor device may be configured to deny continuity restoration and prevent agent state reconstruction even if an agent execution node operating system or runtime is compromised.

### 6.15.4 Hash-Chained Agent State Lineage and Rollback Prevention

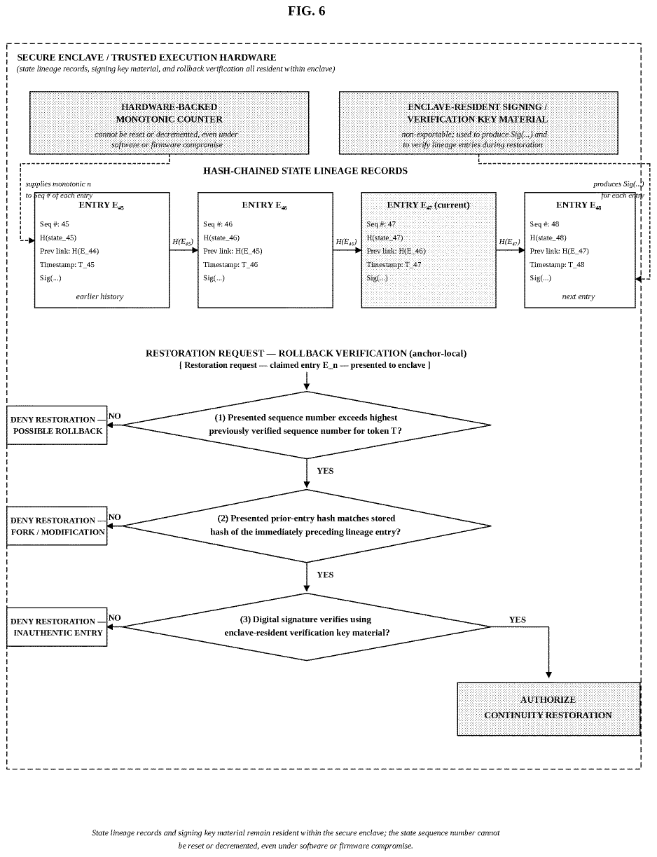

In certain embodiments illustrated in FIG. 6, the continuity anchor device may maintain one or more integrity structures associated with the evolution of agent continuity state. Such integrity structures may include, without limitation: a monotonic sequence identifier; a monotonic counter; a hash-chained state record; a continuity-state digest chain; a rollback-detection marker; a state-version identifier; a custody-linked state-validation record; or combinations thereof.

These integrity structures may prevent unauthorized rollback of the agent to an earlier state, detect state forks and stale-state substitution, and enable cryptographic verification of the integrity of the agent's state history.

For each continuity token associated with an artificial intelligence agent, the continuity anchor device may maintain: a monotonically incrementing state sequence number, initialized at token enrollment and incremented upon each committed update to the indexed agent continuity state data; an agent state lineage record comprising a hash-chained sequence of state lineage entries; and a hardware-backed monotonic counter within the secure enclave or trusted execution hardware, such that the state sequence number cannot be reset or decremented by any software process, firmware update, or external command.

Each state lineage entry, in one embodiment, may comprise: the state sequence number assigned to the entry; a cryptographic hash of the agent continuity state data committed at the corresponding update; a cryptographic hash of the immediately preceding state lineage entry, forming the hash-chain link; a timestamp of the commit event as recorded by a trusted time source within the continuity anchor device; and a digital signature computed over the preceding four fields using cryptographic key material resident within the secure enclave or trusted execution hardware.

In a representative non-limiting embodiment, the state lineage entry at sequence number n may be constructed as E_n comprising the tuple (n, H(state_n), H(E_n-1), T_n, Sig(n∥H(state_n)∥H(E_n-1)∥T_n)), where H denotes a cryptographic hash function such as SHA-256, T_n denotes the commit timestamp, Sig denotes a digital signature computed using an ECDSA or Ed25519 key pair resident within the secure enclave, and ∥ denotes concatenation. Expressed in plain terms, each state lineage entry records the sequence number, a hash of the current state, a hash linking back to the previous lineage entry, a commit timestamp, and a digital signature over those four elements produced using key material that cannot leave the secure enclave. The initial state lineage entry E_0 may use a defined genesis value such as a 256-bit zero value or a device-specific genesis hash as its hash-chain link.

Prior to authorizing a continuity restoration or committing a state update for an agent, the continuity anchor device may perform a state lineage verification process comprising: confirming that the state sequence number presented by the requesting agent execution node exceeds all previously verified state sequence numbers for this continuity token (a presented sequence number less than or equal to a previously verified sequence number may indicate a rollback attempt, in which case restoration may be denied); confirming that the hash-chain link of the presented state entry correctly corresponds to the cryptographic hash of the immediately preceding state lineage entry stored within the secure enclave (non-correspondence may indicate an unauthorized modification or fork, in which case restoration may be denied); and verifying the digital signature of the presented state entry using cryptographic verification key material stored within the secure enclave (verification failure may indicate an inauthentic state entry, in which case restoration may be denied).

The state lineage records may be stored exclusively within the secure enclave or trusted execution hardware of the continuity anchor device and may not be readable, transferable, or verifiable by any remote service. The hash-chain structure may ensure that an adversary in possession of an exported copy of encrypted agent continuity state data cannot forge a valid state lineage entry without access to the continuity anchor device's resident signing key material. The hardware-backed monotonic counter may ensure that the state sequence number cannot be reset or decremented even in the presence of software or firmware compromise. Any attempt to restore agent continuity state from a prior, non-current state record may be denied.

### 6.15.5 Anti-Duplication Attestation and Proof of Custody

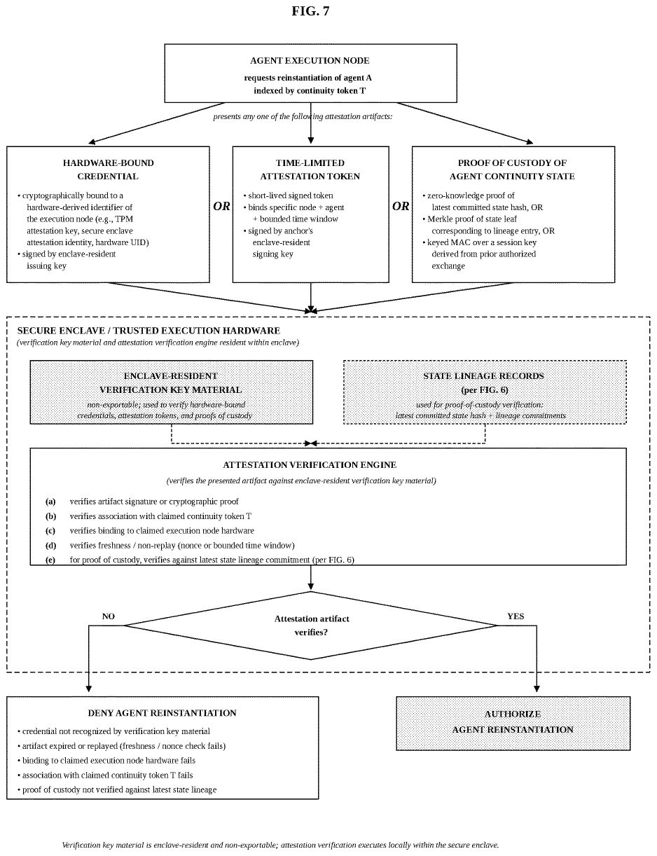

In certain embodiments illustrated in FIG. 7, reinstantiation of an artificial intelligence agent on an agent execution node may be conditioned on local validation by the continuity anchor device of a cryptographic credential, attestation token, or proof of custody of agent continuity state. The attestation verification may prevent unauthorized duplication of an agent onto execution nodes that lack authorized custody of the agent's continuity state. Prior to authorizing reinstantiation, the continuity anchor device may require the requesting agent execution node to present one or more of the following representative non-limiting attestation artifacts.

A hardware-bound credential, in one embodiment, may comprise a cryptographic credential issued by the continuity anchor device to an execution node and cryptographically bound to a hardware-derived identifier of the execution node-for example, a trusted platform module attestation key, a secure enclave attestation identity, or a hardware-derived unique identifier. In a representative non-limiting embodiment, the hardware-bound credential may be an X.509 certificate or equivalent structure in which the subject public key is derived from or attested by hardware-backed key material of the execution node, signed by an issuing key held within the continuity anchor device's secure enclave.

An attestation token, in one embodiment, may comprise a time-limited cryptographic token issued by the continuity anchor device authorizing agent reinstantiation on a specific execution node for a specific time window. In a representative non-limiting embodiment, the attestation token may comprise: an execution node identifier; a continuity token reference; a validity start timestamp; a validity end timestamp; a nonce; and a digital signature over the preceding five fields computed using key material resident within the continuity anchor device's secure enclave. The attestation token may be transmitted to the execution node and may be required to be presented back to the continuity anchor device with each continuity state synchronization message during the validity window.

A proof of custody of agent continuity state, in one embodiment, may comprise cryptographic evidence that the requesting execution node has had authorized access to the most recently committed agent state as recorded in the state lineage of Section 6.15.4. In representative non-limiting embodiments, the proof of custody may be constructed as any one of: a zero-knowledge proof demonstrating that the execution node possesses a value whose cryptographic hash matches the most recent committed state hash recorded in the continuity anchor device's state lineage, without the execution node revealing the underlying state value itself; a Merkle proof demonstrating possession of a state leaf corresponding to a specified state lineage entry; or a keyed message authentication code computed using a session key that was derived from a previous authorized exchange with the continuity anchor device.

The proof of custody may indicate that a requesting execution node possesses a valid, continuity-bound, locally authorized continuity-state fragment or restoration request chain not previously invalidated by the continuity anchor device. Upon receiving an attestation artifact from a requesting execution node, the continuity anchor device may perform verification entirely within its secure enclave or trusted execution hardware using locally stored cryptographic verification material. If verification succeeds, reinstantiation may be authorized. If verification fails, reinstantiation may be denied, a failed-attestation event may be recorded in the local tamper-evident event log, and the safety governance layer may optionally be notified. The attestation verification process does not require network connectivity to any centralized identity provider, remote attestation service, or cloud-hosted credential authority; all attestation artifacts may be issued by, and verifiable against, key material resident within the continuity anchor device.

### 6.15.6 Reconciliation of Concurrent Updates and Buffered Updates During Disconnection

In certain embodiments, two or more agent execution nodes may generate continuity-state updates associated with the same artificial intelligence agent during overlapping or partially overlapping intervals. The continuity anchor device may apply locally executed conflict resolution and reconciliation rules to merge, prioritize, reject, or otherwise resolve overlapping continuity-state updates for agent continuity specifically, as distinguished from the general protocol synchronization described in Section 6.12.

Reconciliation rules may include, without limitation, one or more of: timestamp-based ordering in which earlier-timestamped updates are applied first; session freshness weighting in which updates from more recently active sessions, measured by the most recent last-activity timestamp recorded within the secure enclave, are weighted higher than updates from less recently active sessions; deterministic merge operations for non-conflicting state fragments in which non-overlapping agent continuity state elements from concurrent updates are merged into a single combined update without information loss; rejection of conflicting state fragments according to predefined conflict criteria; preference for updates from a designated execution-node class; preference for the most recent locally validated state; preference for a state chain having the highest continuity confidence or strongest proof of custody; or preservation of prior indexed continuity state pending manual, policy-based, or cryptographically authorized resolution.

Reconciliation results may be written back into the locally encrypted memory store as a new restored continuity-state record associated with the continuity token. Prior continuity-state records may be preserved in encrypted form for rollback detection, audit, safety review, or local recovery control.

In certain embodiments, an agent execution node may continue generating continuity-state updates during periods in which the execution node is temporarily disconnected from the continuity anchor device. During such periods, the execution node may buffer encrypted continuity-state fragments, state deltas, session metadata, or continuity-update records locally.

Upon restoration of communication with the continuity anchor device, the buffered continuity-state updates may be transmitted to the continuity anchor device and reconciled with the locally encrypted memory store according to the reconciliation rules described above. Buffered updates may be accompanied by one or more locally verifiable integrity values including timestamps, counters, digests, state-version identifiers, continuity-fragment identifiers, or locally signed metadata sufficient to support ordering, replay detection, rollback detection, or conflict-resolution processing at the continuity anchor device. Stale, duplicate, replayed, or unauthorized buffered updates may be rejected.

Continuity state synchronization messages exchanged between the continuity anchor device and agent execution nodes may comprise encrypted agent continuity state fragments sufficient to resume agent operation at a point of interruption and insufficient by themselves to reconstruct full agent continuity state content absent locally stored cryptographic key material of the continuity anchor device. Upon session teardown of an agent execution node, the continuity anchor device may trigger cryptographic erasure of transient session keys and cached continuity state fragments stored at the agent execution node, such that agent continuity state is not reconstructible from the agent execution node after termination.

### 6.15.7 Reconciled Continuity Domain for Multi-Agent Operation

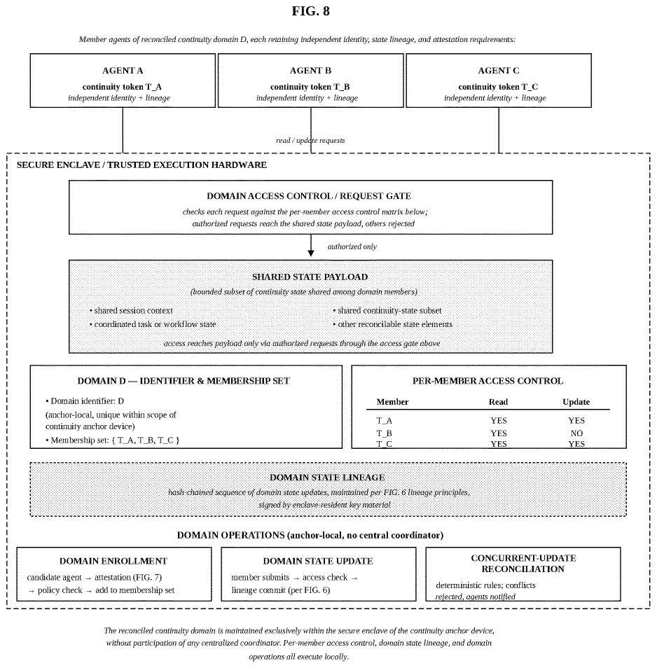

In certain embodiments illustrated in FIG. 8, the continuity anchor device may maintain a reconciled continuity domain enabling coordinated continuity for two or more artificial intelligence agents operating on heterogeneous agent execution nodes. The reconciled continuity domain may allow multiple agents to share a bounded subset of continuity state data while preserving the independent identity, state lineage, and attestation requirements of each individual agent, enabling coordinated or collaborative agent operation while preventing unauthorized cross-agent state leakage.

A reconciled continuity domain, in one embodiment, may comprise a data structure maintained within the encrypted local memory store of the continuity anchor device, including: a domain identifier unique within the scope of the continuity anchor device; a domain membership set listing the continuity tokens of agents that are members of the domain; a shared state payload comprising the subset of continuity state data that is shared among domain members; a per-member access control record specifying which elements of the shared state payload each member agent may read or update; and a domain state lineage, which may be maintained according to the hash-chained state lineage principles of Section 6.15.4.

Agents may be added to a reconciled continuity domain through a domain enrollment operation executed by the continuity anchor device, which may comprise: receiving a domain enrollment request identifying the continuity token of the candidate member agent; verifying the candidate agent's attestation artifacts according to Section 6.15.5; evaluating domain membership policy, which may include safety governance conditions, capacity constraints, or policy-mode restrictions; and upon successful evaluation, adding the candidate continuity token to the domain membership set and granting access to the shared state payload according to the per-member access control record.

When a domain member agent submits a state update affecting the shared state payload, the continuity anchor device may verify the member agent's attestation artifacts according to Section 6.15.5; verify the member agent's permission to update the affected shared state elements according to the per-member access control record; verify the state lineage consistency of the submitted update according to Section 6.15.4; commit the update to the shared state payload and append a corresponding entry to the domain state lineage; and propagate notification of the update to other domain members according to the notification policy of the domain.

Reconciliation of concurrent updates from two or more domain member agents may be performed by one or more processors of the continuity anchor device applying the reconciliation rules described in Section 6.15.6. Conflicting updates that cannot be resolved deterministically may be rejected and the originating agents notified.

The reconciled continuity domain does not constitute centralized identity infrastructure. The domain may exist solely within the encrypted local memory store of the continuity anchor device, with all access control, state lineage verification, attestation, and reconciliation operations performed locally within the continuity anchor device's secure enclave or trusted execution hardware. No remote service, cloud-hosted coordinator, or centralized identity provider participates in the operation of a reconciled continuity domain.

### 6.15.8 Safety Governance, Policy Modes, and Offline Operation

In certain embodiments, the safety governance layer of the continuity anchor device, as described in the parent disclosure, may retain supervisory control over agent continuity operations described in this Section 6.15. The safety governance layer may monitor one or more of: biometric indicators of a human user associated with the continuity anchor device; interaction-derived signals associated with the user or the agent; device tamper conditions; duplication or divergence conditions; privilege or entitlement status; policy-profile conditions; or regulatory or enterprise constraints. The safety governance layer may condition restoration of agent continuity state on satisfaction of one or more locally evaluated safety conditions.

Upon detection of a predefined safety event—including without limitation tamper detection, user distress indicators where applicable, prolonged absence of authenticated activity, detection of a divergent instantiation condition per Section 6.15.3, a predetermined number of consecutive attestation failures from a given execution node (for example, three to five consecutive failures within a bounded time window), or explicit user erasure commands—the safety governance layer may: suspend continuity restoration for one or more agents; initiate cryptographic erasure of agent continuity state data, state lineage records, and reconciled continuity domain state; invalidate continuity tokens and associated attestation artifacts; and lock the continuity anchor device against further continuity operations until authorized reset occurs.

In certain embodiments, the continuity anchor device may operate agent continuity management according to one or more dynamically selectable policy profiles consistent with the policy-adaptive continuity operation of the parent disclosure. The policy profiles selectable in embodiments of this Section 6.15 may include, without limitation: a fully private local-operation mode in which agent continuity tokens, state data, state lineage records, attestation artifacts, and reconciled continuity domain state are generated, stored, matched, and erased exclusively on the continuity anchor device without any external reporting; a regulated compliance mode in which a subset of cryptographically verifiable metadata—which may include agent state lineage commitments, domain membership changes, or attestation failure events—is escrowed, encrypted, or transmitted to a designated compliance validation endpoint, without exposure of personality parameter profiles, behavioral preference vectors, constraint matrices, or other substantive agent state content; and a hybrid operation mode in which agent continuity management remains local while audit confirmation receipts are periodically synchronized to compliance infrastructure systems.

In all policy modes, continuity-token derivation, similarity-threshold evaluation, encrypted indexing, reconciliation, and restoration authorization for the artificial intelligence agent may remain locally executed at the continuity anchor device. All continuity-token derivation, similarity evaluation, continuity-state indexing, divergent instantiation detection, anti-duplication validation, reconciliation, and restoration authorization operations for an artificial intelligence agent may be executable in a fully offline mode without requiring network connectivity as a prerequisite. The continuity anchor device may maintain persistent operational identity of the artificial intelligence agent across heterogeneous execution nodes using only locally retained continuity tokens, encrypted continuity-state data, locally stored cryptographic key material, buffered state updates, and locally applied policy and safety controls. Remote commands, cloud-based policy directives, or external authority instructions are not by themselves sufficient to authorize policy mode changes, override safety governance decisions, or release a safety-governance-imposed lock state; any such change, override, or release may require anchor-local cryptographic authorization using key material resident within the secure enclave or trusted execution hardware of the continuity anchor device.

### ALTERNATIVE EMBODIMENTS

The present disclosure may be implemented across a wide range of hardware and software substrates including but not limited to:
wearable pendants, bracelets, rings, or head-mounted devices;
implanted computing modules or medical-grade devices;
hybrid biometric authentication accessories;
vehicle-mounted biometric terminals and infotainment systems;
robotic interface relays and home automation hubs;
satellite uplink identity modules and spaceborne computing systems;
secure virtualization containers or distributed ledger-anchored identities.

Communication methods may include wired ports, wireless RF links, Bluetooth Low Energy (BLE) communications, satellite uplinks, optical transceivers, bio-electrical couplings, or other physical or wireless channels.

Cryptographic derivation algorithms may include but are not limited to hashing, rolling entropy derivation, zero-knowledge proof tokenization, homomorphic encryption-assisted comparisons, or secure enclave-processed biometric transformations.

### CONCLUSION

The present disclosure enables secure and privacy-preserving continuity of interactive computing sessions across distributed devices without dependence on centralized cloud identity infrastructures or storage of personal biometric identifiers. By employing local continuity token derivation, encrypted local memory indexing, offline-capable continuity restoration, protocol-based synchronization, and distributed agent continuity management with divergent instantiation detection, hash-chained state lineage, and anti-duplication attestation, the disclosed technology advances the state of biometric and interaction-based continuity computing systems for both human and digital personas.

1. A distributed agent continuity management system for maintaining persistent operational identity of an artificial intelligence agent across heterogeneous agent execution nodes or computing platforms, comprising:
a) a continuity anchor device configured to locally execute continuity token derivation, encrypted memory indexing, similarity matching, and continuity restoration operations, the continuity anchor device comprising secure enclaves or trusted execution hardware storing a device-specific or environment-specific secret value;
b) an identity derivation engine implemented by one or more processors of the continuity anchor device and configured to derive a non-invertible continuity token from one or more of digital persona signatures, behavioral interaction profiles, or autonomous agent state fingerprints associated with the artificial intelligence agent, combined with the device-specific or environment-specific secret value;
c) a locally encrypted memory store indexed to the continuity token and storing encrypted agent continuity state data comprising at least one of personality parameter profiles, interaction cadence parameters, behavioral preference vectors, or constraint matrices;
d) a continuity restoration engine implemented by one or more processors of the continuity anchor device and configured to evaluate a similarity metric between a re-derived continuity token and one or more stored reference continuity tokens against a predefined continuity confidence threshold, and to restore agent continuity state data indexed to the stored reference continuity token when the similarity metric satisfies the predefined continuity confidence threshold; and
e) one or more agent execution nodes configured to instantiate operation of the artificial intelligence agent while exchanging continuity state synchronization messages with the continuity anchor device, the agent execution nodes being implemented on heterogeneous computing platforms,
wherein the distributed agent continuity management system maintains persistent agent operational identity across heterogeneous agent execution nodes or computing platforms without requiring persistent centralized identity provider authentication or cloud-hosted memory retrieval as a prerequisite to continuity restoration, wherein continuity restoration requires anchor-local validation using cryptographic key material retained by the continuity anchor device, and wherein any remote authentication event, cloud-based identity validation, federated identity assertion, or external authorization event is insufficient by itself to authorize continuity restoration absent local validation within the continuity anchor device.

2. The system of claim 1, wherein the digital persona signatures, behavioral interaction profiles, or autonomous agent state fingerprints comprise at least one of: agent behavioral fingerprints derived from response latency, token output rate, or session initiation cadence; cryptographically derived interaction-state signatures; or session state hashes associated with the artificial intelligence agent.

3. The system of claim 1, wherein the continuity anchor device is further configured to deny restoration of agent continuity state data upon detection of a mismatch between a re-derived continuity token and all stored reference continuity tokens, the detection comprising evaluation of the similarity metric against the predefined continuity confidence threshold, and to invalidate the stored continuity token and indexed agent continuity state data upon detection of unauthorized access or tampering by tamper detection circuits of the continuity anchor device.

4. The system of claim 1, wherein the continuity anchor device is further configured to deny restoration upon detection of a divergent instantiation condition comprising detection of concurrent active agent sessions indexed to the same continuity token from two or more agent execution nodes, the detection comprising comparison of session state metadata received from the two or more agent execution nodes against continuity state data stored in the locally encrypted memory store.

5. The system of claim 1, wherein one or more processors of the continuity anchor device are configured to reconcile concurrent agent continuity state updates received from two or more agent execution nodes by applying conflict resolution rules comprising at least one of timestamp-based ordering, session freshness weighting in which updates from more recently active sessions measured by most recent last-activity timestamp are weighted higher, or deterministic merge operations combining non-conflicting state fragments, the conflict resolution rules being applied at the continuity anchor device using cryptographic key material resident within the secure enclaves or trusted execution hardware.

6. The system of claim 1, wherein the predefined continuity confidence threshold is evaluated using at least one of Hamming distance, cosine distance, Euclidean distance, correlation scoring, or probabilistic confidence scoring applied between the re-derived continuity token and the stored reference continuity token.

7. The system of claim 1, wherein agent continuity state updates generated at one or more agent execution nodes during periods of disconnection from the continuity anchor device are buffered locally at the agent execution node and reconciled with the locally encrypted memory store of the continuity anchor device upon restoration of communication.

8. The system of claim 1, wherein the agent continuity state data further comprises privilege parameters comprising at least one of resource allocations, delegated permissions, execution thresholds, or entitlement states indexed to the continuity token.

9. The system of claim 1, further comprising a safety governance layer configured to monitor at least one of biometric indicators, interaction-derived signals, or device tamper conditions, and to control continuity restoration eligibility by conditioning restoration on satisfaction of at least one safety condition evaluated locally at the continuity anchor device, wherein the safety governance layer is configured to initiate cryptographic erasure of stored continuity tokens and agent continuity state data upon detection of a predefined safety event.

10. The system of claim 1, wherein the continuity anchor device operates under dynamically selectable policy profiles comprising at least a fully private local-operation mode, a regulated compliance mode, and a hybrid operation mode, wherein continuity token derivation, similarity matching, memory indexing, and restoration logic remain locally executed on the continuity anchor device regardless of the selected policy profile.

11. The system of claim 1, wherein the agent continuity state data includes a monotonic sequence identifier or a hash-chained state record configured to detect rollback or unauthorized reversion of agent continuity state to a prior state.

12. The system of claim 1, wherein reinstantiation of the artificial intelligence agent on an agent execution node is conditioned on local validation of a cryptographic credential, attestation token, or proof of custody of agent continuity state by the continuity anchor device using locally stored cryptographic key material of the continuity anchor device, the local validation being performed at the continuity anchor device without requiring remote authentication as a prerequisite.

13. The system of claim 1, wherein continuity state synchronization messages exchanged between the continuity anchor device and agent execution nodes comprise encrypted agent continuity state fragments sufficient to resume agent operation at a point of interruption and insufficient by themselves to reconstruct full agent continuity state content absent locally stored cryptographic key material of the continuity anchor device.

14. The system of claim 1, wherein session teardown of an agent execution node triggers cryptographic erasure of transient session keys and cached continuity state fragments stored at the agent execution node, ensuring that agent continuity state is not reconstructible from the agent execution node after session termination.

15. The system of claim 1, wherein two or more artificial intelligence agents operating on heterogeneous agent execution nodes share a reconciled continuity domain maintained by the continuity anchor device, the reconciled continuity domain comprising shared agent continuity state data indexed to respective continuity tokens of each agent.

16. The system of claim 1, wherein the continuity anchor device enforces anti-duplication safeguards by conditioning restoration on local validation of a cryptographic credential or attestation token that is cryptographically bound to the continuity token and verified by the continuity anchor device using locally stored cryptographic key material, such that restoration is denied to any agent execution node that cannot present a valid credential bound to the continuity token.

17. A computer-implemented method for maintaining persistent identity continuity of an artificial intelligence agent across heterogeneous agent execution nodes or computing platforms, executed by a continuity anchor device comprising secure enclaves or trusted execution hardware, the method comprising:
a) deriving a non-invertible continuity token from one or more of digital persona signatures, behavioral interaction profiles, or autonomous agent state fingerprints associated with the artificial intelligence agent, combined with a device-specific or environment-specific secret value;
b) storing encrypted agent continuity state data indexed to the continuity token within a locally encrypted memory store of the continuity anchor device;
c) detecting re-derivation of a continuity token following an interruption event or agent migration;
d) evaluating a similarity metric between the re-derived continuity token and one or more stored reference continuity tokens against a predefined continuity confidence threshold; and
e) restoring, locally at the continuity anchor device, agent continuity state data indexed to the stored reference continuity token across one or more agent execution nodes when the similarity metric satisfies the predefined continuity confidence threshold and anchor-local validation using cryptographic key material retained by the continuity anchor device is satisfied, without requiring persistent centralized identity provider authentication or cloud-hosted memory retrieval as a prerequisite to restoration, and wherein any remote authentication event, cloud-based identity validation, federated identity assertion, or external authorization event is insufficient by itself to authorize continuity restoration absent local validation within the continuity anchor device.

18. The method of claim 17, further comprising denying restoration upon detection of a divergent instantiation condition comprising detection of concurrent active agent sessions indexed to the same continuity token from two or more agent execution nodes.

19. The method of claim 17, further comprising reconciling concurrent agent continuity state updates received from two or more agent execution nodes by applying conflict resolution rules comprising at least one of timestamp-based ordering, session freshness weighting in which updates from more recently active sessions measured by most recent last-activity timestamp are weighted higher, or deterministic merge operations.

20. The method of claim 17, further comprising buffering agent continuity state updates at one or more agent execution nodes during periods of disconnection from the continuity anchor device and reconciling buffered updates upon restoration of communication.

21. The method of claim 17, further comprising conditioning continuity restoration eligibility on satisfaction of at least one safety condition evaluated locally at the continuity anchor device using a safety governance layer, and initiating cryptographic erasure of stored continuity tokens and agent continuity state data upon detection of a predefined safety event.

22. A non-transitory computer-readable medium storing machine-executable instructions that, when executed by one or more processors of a continuity anchor device comprising secure enclaves or trusted execution hardware, cause the continuity anchor device to:
a) derive a non-invertible continuity token from one or more of digital persona signatures, behavioral interaction profiles, or autonomous agent state fingerprints associated with an artificial intelligence agent, combined with a device-specific or environment-specific secret value stored within the secure enclaves or trusted execution hardware;
b) store encrypted agent continuity state data indexed to the continuity token within a locally encrypted memory store of the continuity anchor device;
c) evaluate a similarity metric between a re-derived continuity token and one or more stored reference continuity tokens against a predefined continuity confidence threshold;
d) restore agent continuity state data indexed to the stored reference continuity token across one or more agent execution nodes when the similarity metric satisfies the predefined continuity confidence threshold and anchor-local validation using cryptographic key material retained by the continuity anchor device is satisfied, without requiring persistent centralized identity provider authentication or cloud-hosted memory retrieval as a prerequisite; and
e) deny restoration upon detection of a tamper event by tamper detection circuits of the continuity anchor device, initiating cryptographic erasure of stored continuity tokens and encrypted agent continuity state data,
wherein persistent centralized identity provider authentication and cloud-hosted memory retrieval are not required as prerequisites to continuity restoration, and wherein any remote authentication event, cloud-based identity validation, federated identity assertion, or external authorization event is insufficient by itself to authorize continuity restoration absent local validation within the continuity anchor device.

23. The non-transitory computer-readable medium of claim 22, further causing the continuity anchor device to deny restoration upon detection of a divergent instantiation condition comprising concurrent active agent sessions indexed to the same continuity token from two or more agent execution nodes.

24. The non-transitory computer-readable medium of claim 22, further causing the continuity anchor device to reconcile concurrent agent continuity state updates from two or more agent execution nodes by applying conflict resolution rules comprising at least one of timestamp-based ordering, session freshness weighting in which updates from more recently active sessions measured by most recent last-activity timestamp are weighted higher, or deterministic merge operations.

25. The system of claim 1, wherein the secure enclaves or trusted execution hardware of the continuity anchor device store locally stored cryptographic key material that is inaccessible to a general-purpose processor or operating system of the continuity anchor device, and wherein continuity token derivation and similarity matching operations are executed at least in part within the secure enclaves or trusted execution hardware.

26. The system of claim 1, wherein the continuity token is derived by applying a cryptographic hashing function to a concatenation of (i) a stabilized intermediate representation of one or more of the digital persona signatures, behavioral interaction profiles, or autonomous agent state fingerprints, the stabilized intermediate representation being produced within the secure enclaves or trusted execution hardware by at least one of a fuzzy extractor, a secure sketch with helper data, a locality-sensitive hashing function, an error-correcting code applied to a quantized feature representation, or an enclave-internal stabilized feature representation, and (ii) the device-specific or environment-specific secret value, and wherein agent continuity restoration is authorized by evaluating the similarity metric between a re-derived continuity token and one or more stored reference continuity tokens against the predefined continuity confidence threshold, or alternatively by evaluating the similarity metric between corresponding stabilized intermediate representations within the secure enclaves or trusted execution hardware prior to final cryptographic token commitment.

27. The system of claim 1, wherein continuity token validation and authorization of agent continuity state restoration are performed locally at the continuity anchor device rather than at the agent execution node, and wherein the continuity anchor device is configured to deny continuity restoration and to withhold encrypted agent continuity state content sufficient to prevent reconstruction of full agent operational identity when the agent execution node fails to present a valid attestation artifact, the attestation artifact comprising at least one of a hardware-bound credential, an attestation token, or a proof of custody of agent continuity state, verified by the continuity anchor device using locally stored cryptographic verification material resident within the secure enclaves or trusted execution hardware.

28. The system of claim 1, wherein the continuity anchor device operates without network connectivity as a prerequisite, and wherein all continuity token derivation, similarity metric evaluation, agent continuity state indexing, and restoration authorization operations are executable in a fully offline mode.

29. The system of claim 1, wherein the agent continuity state data stored in the locally encrypted memory store comprises only encrypted state fragments indexed to the continuity token, such that raw agent behavioral parameters, constraint matrices, and privilege parameters are retained only in encrypted form within the continuity anchor device, and wherein restoration of agent operational state from the encrypted state fragments requires locally stored cryptographic key material of the continuity anchor device.

30. A distributed agent continuity management system for maintaining persistent operational
identity of an artificial intelligence agent across heterogeneous agent execution nodes, comprising:
a) a continuity anchor device comprising secure enclaves or trusted execution hardware storing a device-specific or environment-specific secret value and locally retained cryptographic key material;
b) an identity derivation engine implemented by one or more processors of the continuity anchor device and configured to derive a non-invertible continuity token from one or more of digital persona signatures, behavioral interaction profiles, or autonomous agent state fingerprints associated with the artificial intelligence agent, combined with the device-specific or environment-specific secret value, the deriving comprising production of a stabilized intermediate representation by at least one of a fuzzy extractor, a secure sketch with helper data, a locality-sensitive hashing function, or an enclave-internal stabilized feature representation prior to final cryptographic token commitment;
c) a locally encrypted memory store indexed to the continuity token and storing encrypted agent continuity state data comprising at least one of personality parameter profiles, interaction cadence parameters, behavioral preference vectors, constraint matrices, or privilege parameters; and
d) a continuity restoration engine implemented by one or more processors of the continuity anchor device and configured to evaluate a similarity metric between a re-derived continuity token and one or more stored reference continuity tokens against a predefined continuity confidence threshold and to restore agent continuity state data when the similarity metric satisfies the predefined continuity confidence threshold and anchor-local validation using the locally retained cryptographic key material is satisfied,
wherein the encrypted agent continuity state data provided by the continuity anchor device to any agent execution node comprises only encrypted state fragments insufficient by themselves to reconstruct full agent operational identity absent the locally retained cryptographic key material of the continuity anchor device, and wherein remote authentication events, cloud-based identity validation, federated identity assertion, and external authorization events are insufficient by themselves to authorize continuity restoration absent local validation within the continuity anchor device.
